(19) United States
(12) Patent Application Publication
(10) Pub. No.: US 2024/0410280 A1
(43) Pub. Date: Dec. 12, 2024

(54) METHOD FOR SELECTING PARAMETERS FOR TUNNEL SUPPORT BASED ON ENGINEERING-ORIENTED BEHAVIOR DISCRIMINATION OF SURROUNDING ROCK

(71) Applicants: Gang LEI, Beijing (CN); Fucai HUA, Beijing (CN); Beijing Urban Construction Design&Development Group Co., Limited, Beijing (CN)

(72) Inventors: Gang LEI, Beijing (CN); Fucai HUA, Beijing (CN); Zhihui YANG, Beijing (CN); Jianye ZHU, Beijing (CN); Chao LI, Beijing (CN)

(73) Assignees: Gang LEI, Beijing (CN); Fucai HUA, Beijing (CN); Beijing Urban Construction Design&Development Group Co., Limited, Beijing (CN)

(21) Appl. No.: 18/401,727

(22) Filed: Jan. 2, 2024

(30) Foreign Application Priority Data
Jun. 9, 2023 (CN) 202310683106.5

(51) Int. Cl. E21D 9/14; G01N 3/40

(52) U.S. Cl. CPC E21D 9/14; G01N 3/40

(57) ABSTRACT

A method for selecting parameters for tunnel support based on engineering-oriented behavior discrimination of surrounding rock includes: obtaining basic geological data of a running tunnel, establishing a model of a relative location relationship between the running tunnel and a stratum, and determining a chamber environment classification of a surrounding rock of the running tunnel; determining rock integrity of the surrounding rock of the running tunnel based on the basic geological data; determining a groundwater development level of the surrounding rock of the running tunnel based on the basic geological data; determining, based on the basic geological data, whether there is a slip surface on the surrounding rock of the running tunnel; and selecting support parameters for a corresponding support measure based on behavior of the surrounding rock including the chamber environment classification, the rock integrity, the groundwater development level, and whether the slip surface exists.

### CROSS-REFERENCE TO RELATED APPLICATIONS

This application claims priority to Chinese Patent Application No. 202310683106.5 with a filing date of Jun. 9, 2023. The content of the aforementioned application, including any intervening amendments thereto, is incorporated herein by reference.

### TECHNICAL FIELD

The present disclosure relates to the technical field of tunnel engineering, and in particular, to a method for selecting parameters for tunnel support based on engineering-oriented behavior discrimination of surrounding rock.

### BACKGROUND

A subway line is constituted by stations and sections. The section is a main artery connecting stations at both ends, accounting for about 80% of a total mileage of the line. Due to a complex construction process, a high risk, and a high cost, a single-line section in compliance with a mine tunneling method becomes a focus of attention from all parties. Therefore, it is necessary to determine a reasonable and economical method for designing tunneling support parameters.

At present, according to a commonly used method in designing the tunneling support parameters for the single-line section in compliance with the mine tunneling method in China, support systems are designed based on different surrounding rock classifications provided by an exploration unit and engineering analogy experience. As shown in FIG. 2, one surrounding rock classification corresponds to one support system. This results in three problems. Firstly, a traditional surrounding rock classification does not consider a characteristic of underground engineering. Regardless of a type of engineering, a surrounding rock classification at a certain location is fixed and cannot reflect a geological risk based on the characteristic of the engineering. This makes it difficult to grasp the essence of the problem in designing a support measure. Secondly, a single surrounding rock classification includes a combination of a plurality of surrounding rock conditions, which blurs mechanical behavior of a surrounding rock. Thirdly, a single surrounding rock classification corresponds to a plurality of support methods. In order to ensure construction safety, such a general support design method often adopts an envelope design, which can easily lead to excessive support and waste a lot of manpower and material resources.

For example, the commonly used “Code for Geotechnical Investigations of Urban Rail Transit” has a statement on the surrounding rock classification: “If there is groundwater in III-grade, IV-grade, and V-grade surrounding rocks, a surrounding rock grade can be appropriately reduced based on a specific situation and construction condition.” Therefore, when a geological exploration unit provides a designing institute with a V-grade surrounding rock classification, it is possible that the surrounding rock is locally affected by a geological structure and falls into a grade V, or the surrounding block may be downgraded from a grade IV to a grade V due to presence of the groundwater. Due to this uncertainty, a V-grade surrounding rock support system adopts an advanced small conduit, a grid steel frame with a spacing of 0.75 m, and shotcrete with a thickness of 250 m for a section arch, and adopts 1.2 m×1.2 m system anchor bolts on two side walls. In fact, if the small conduit is installed on a support due to the groundwater, after the small conduit is installed, a 1 m grid spacing can be adopted, and the system anchor bolts on the two side walls can also be canceled. It can be seen that a current initial support design has carried out the envelope design for various most unfavorable situations of a certain surrounding rock classification, resulting in a large amount of engineering waste.

To address the above problems, the present disclosure provides a method in designing support parameters based on an oriented engineering object and surrounding rock behavior of a running tunnel, including a chamber environment, rock integrity, a joint fissure development level, a groundwater development level, a local slip surface, and other indicators. The method does not adopt original surrounding rock classification steps, and it directly provides a correspondence between the surrounding rock behavior indicators and support parameters of the support system. This overcomes engineering waste caused by insufficient logicality and poor pertinence of the original design method.

### SUMMARY OF PRESENT INVENTION

The present disclosure provides a method for selecting parameters for tunnel support based on engineering-oriented behavior discrimination of surrounding rock, to resolve problems of insufficient logicality and poor pertinence of an existing surrounding rock classification design method, avoid designing insufficient or excessive support parameters for a running tunnel, and reduce an engineering cost of a single-line section in compliance with a mine tunneling method while ensuring safety.

A method for selecting parameters for tunnel support based on engineering-oriented behavior discrimination of surrounding rock provided in the present disclosure includes:
Step 1, obtaining basic geological data of a running tunnel, establishing a model of a relative location relationship between the running tunnel and a stratum, and determining a chamber environment classification of a surrounding rock of the running tunnel;
Step 2, determining rock integrity of the surrounding rock of the running tunnel based on the basic geological data;
Step 3, determining a groundwater development level of the surrounding rock of the running tunnel based on the basic geological data;
Step 4, determining, based on the basic geological data, whether there is a slip surface on the surrounding rock of the running tunnel; and
Step 5, selecting support parameters for a corresponding support measure based on behavior of the surrounding rock including the chamber environment classification, the rock integrity, the groundwater development level, and whether the slip surface exists.

Preferably, the step 1 includes:
Step 11, determining hardness of the surrounding rock at a location of a vault of the running tunnel based on saturated uniaxial compressive strength of the rock in the basic geological data, and dividing the vault of the running tunnel into a hard rock region, a secondly-hard rock region, a soft rock region, and other stratigraphic regions based on the hardness;
Step 12, determining first, second, and third safety thicknesses of an overlying rock above the vault of the running tunnel based on a division result of the vault;
Step 13, determining a first distance from the vault of the running tunnel to a top boundary of the hard rock region based on the basic geological data, and when the first distance is greater than or equal to the first safety thickness, determining the chamber environment classification of the running tunnel as a grade A;
Step 14, when the first distance is less than the first safety thickness, determining a second distance from the vault of the running tunnel to a top boundary of the secondly-hard rock region, and if the second distance is greater than or equal to the second safety thickness, determining the chamber environment classification of the running tunnel as a grade B; and
Step 15, when the second distance is less than the second safety thickness, determining a third distance from the vault of the running tunnel to a top boundary of the soft rock region, and if the third distance is greater than or equal to the third safety thickness, determining the chamber environment classification of the running tunnel as a grade C.

Preferably, the step 12 includes:
Step 121, calculating an equivalent loosening circle thickness L of a rock stratum of the running tunnel by using a following formula based on the basic geological data:

$$L = 1.4 {r}_{t} ( {( \frac{γ h}{1.5 {f}_{r}} + 0.3 )}^{0.5} - 1 )$$

where rₜ represents an equivalent circle radius of the tunnel, rₜ=\sqrt{A/π}, A represents cross-sectional area of the running tunnel, γ represents a weight of the surrounding rock, fᵣ represents uniaxial compressive strength of the rock, and h represents a burial depth of the tunnel;
Step 122, determining a minimum overlying rock thickness of each rock stratum region on a roof of the running tunnel, where
a minimum overlying rock thickness of the hard rock region is calculated according to

$${H}_{1} = \sqrt{\frac{P B}{2 σ}} ;$$

a minimum overlying rock thickness of the secondly-hard rock region is calculated according to

$${H}_{2} = \sqrt{\frac{3 P B}{4 σ}} ;$$

and
a minimum overlying rock thickness of the soft rock region is calculated according to

$${H}_{3} = \sqrt{\frac{3 P B}{σ}} ,$$

where P represents soil pressure of all strata above the vault, B represents a section width, and σ represents flexure strength of the rock; and
Step 123, determining the first, second, and third safety thicknesses of the overlying rock above the vault of the running tunnel based on the equivalent loosening circle thickness L and the minimum overlying rock thickness of each rock stratum region on the roof of the running tunnel.

Preferably, the step 123 includes:
Step 1231, determining the first safety thickness of the overlying rock above the vault of the running tunnel based on the equivalent loosening circle thickness L and the minimum overlying rock thickness of the hard rock region;
Step 1232, determining the second safety thickness of the overlying rock above the vault of the running tunnel based on the equivalent loosening circle thickness L and the minimum overlying rock thickness of the secondly-hard rock region; and
Step 1233, determining the third safety thickness of the overlying rock above the vault of the running tunnel based on the equivalent loosening circle thickness L and the minimum overlying rock thickness of the soft rock region.

Preferably, the step 2 includes:
Step 21, determining a compression wave velocity u of a rock mass and a compression wave velocity u₀ of a rock block for a surrounding rock environment of the vault of the running tunnel based on the basic geological data;
Step 22, calculating an integrity coefficient k of the running tunnel based on the compression wave velocity u of the rock mass and the compression wave velocity u₀ of the rock block:

$$k = {( \frac{u}{{u}_{0}} )}^{2} ;$$

and
Step 23, determining the rock integrity of the surrounding rock of the vault based on the integrity coefficient k and a preset rock integrity classification table.

Preferably, the rock integrity is classified into three types based on the preset rock integrity classification table: intact, relatively intact, and relatively fractured.

Preferably, the step 3 includes:
Step 31, determining, based on the basic geological data, a distance h from a center of the running tunnel to a phreatic line and a thickness hᵢ of each different stratum located below a groundwater level and above the center of the running tunnel;
Step 32, determining, based on the basic geological data, a permeability coefficient kᵢ of each different stratum located below the groundwater level and above the center of the running tunnel;
Step 33, calculating a comprehensive permeability coefficient K according to a following formula:

$$K = \frac{{\sum }_{i}^{n} {h}_{i}}{{\sum }_{i}^{n} ( {h}_{i} / {k}_{i} )} ;$$

Step 34, calculating an equivalent circle radius rₜ of the running tunnel according to rₜ=\sqrt{A/π}, where A represents area of the running tunnel;
Step 35, determining and calculating a water inflow Q₀ per linear meter in a section based on the basic geological data:

$${Q}_{0} = \frac{2 π K h}{ln ( 2 h / {r}_{t} )} ;$$

and
Step 36, based on the water inflow Q₀ per linear meter in the section and a preset groundwater development level classification table, classifying the groundwater development level of the surrounding rock of the running tunnel into developed and undeveloped.

Preferably, the step 4 includes: determining, based on the basic geological data, whether the running tunnel passes through a large stratigraphic structural plane; and when the running tunnel passes through the stratigraphic structural plane, determining that the slip surface exists; or when the running tunnel does not pass through the stratigraphic structural plane, determining that no slip surface exists.

Preferably, the step 5 includes:
Step 51, determining four behavior indicators of the surrounding rock of the running tunnel: the chamber environment classification, the rock integrity, the groundwater development level, and whether the slip surface exists;
Step 52, determining a preset table for selecting a structural support parameter; and
Step 53, searching for support parameters for all support measures based on the four behavior indicators of the surrounding rock of the running tunnel and the preset table for selecting the structural support parameter.

Preferably, the method further includes a step 6: determining a corresponding support parameter profile design drawing based on determining results of the support parameters of all the support measures.

The present disclosure resolves problems of insufficient logicality and poor pertinence of an existing surrounding rock classification design method, avoid designing insufficient or excessive support parameters for the running tunnel, and reduce an engineering cost of a single-line section in compliance with a mine tunneling method while ensuring safety.

Other features and advantages of the present disclosure will be illustrated in the following description, and some of these will become apparent from the description or be understood by implementing the present disclosure. The objectives and other advantages of the present disclosure may be realized and attained by the structure particularly pointed out in the written specification, the claims, and the accompanying drawings.

The technical solutions of the present disclosure will be further described in detail below with reference to accompanying drawings and embodiments.

### BRIEF DESCRIPTION OF THE DRAWINGS

The accompanying drawings are provided for further understanding of the present disclosure and constitute a part of the specification. The accompanying drawings, together with the embodiments of the present disclosure, are intended to explain the present disclosure, rather than to limit the present disclosure. In the accompanying drawings:

FIG. 1 is a flowchart showing steps of a method for selecting parameters for tunnel support based on engineering-oriented behavior discrimination of surrounding rock according to an embodiment of the present disclosure;

FIG. 2 shows drawbacks of a design concept of a single-line section in compliance with a conventional mine tunneling method in the prior art;

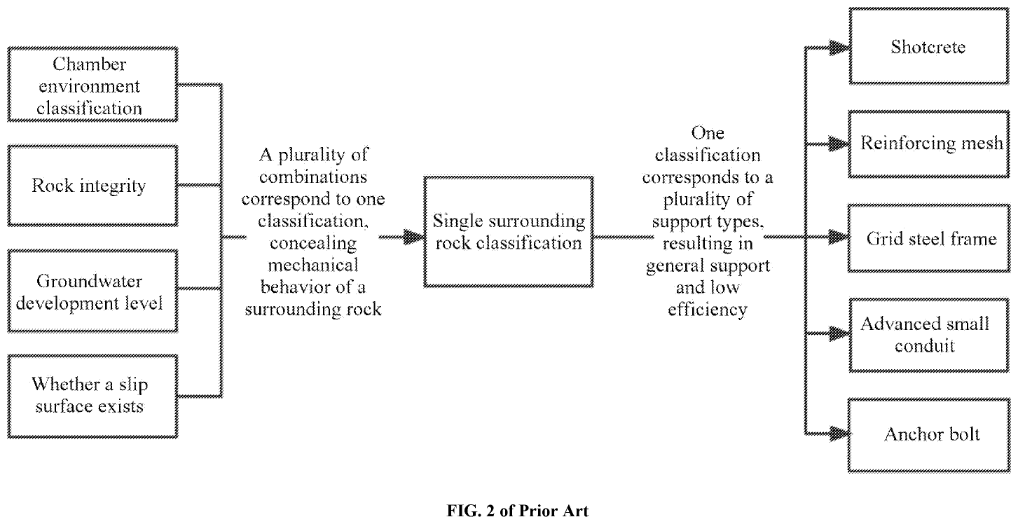

FIG. 3 shows a correspondence between a support parameter and surrounding rock behavior;

FIG. 4 is a schematic diagram of a grade-A chamber environment of a running tunnel according to an embodiment of the present disclosure;

FIG. 5 is a schematic diagram of a grade-B chamber environment of a running tunnel according to an embodiment of the present disclosure;

FIG. 6 is a schematic diagram of a grade-C chamber environment of a running tunnel according to an embodiment of the present disclosure; and

FIG. 7 is a schematic diagram of calculating a water inflow Q₀ per linear meter in a running tunnel.

### DETAILED DESCRIPTION OF THE EMBODIMENTS

The preferred embodiments of the present disclosure are described below with reference to the accompanying drawings. It should be understood that the preferred embodiments described herein are only used to illustrate the present disclosure, rather than to limit the present disclosure.

A core of the present disclosure lies in providing two new methods based on surrounding rock behavior of a single-line section: a discrimination method for a surrounding rock environment of a single-line section in compliance with a mine tunneling method, and a targeted support selection method for a running tunnel. The discrimination method is a prerequisite for the targeted support selection method. According to the present disclosure, section designers can quickly and accurately design support parameters for the single-line section in compliance with the mine tunneling method. A correspondence between a selected support parameter and the surrounding rock behavior is achieved. Behavior indicators of the surrounding rock mainly include: a chamber environment classification, rock integrity, a groundwater development level, and whether a slip surface exists. The support parameters mainly include: a shotcrete thickness, a spacing of a triangular grid steel frame, a model and a spacing of a reinforcing mesh, a model and a spacing of an advanced small conduit, and an anchor bolt.

The chamber environment classification is classified into a grade A, a grade B, and a grade C.

The rock integrity is classified into three levels: intact, relatively intact, and relatively fractured.

The groundwater development level is classified into developed and undeveloped.

Whether the slip surface exists is classified into that the slip surface exists and that the slip surface does not exist.

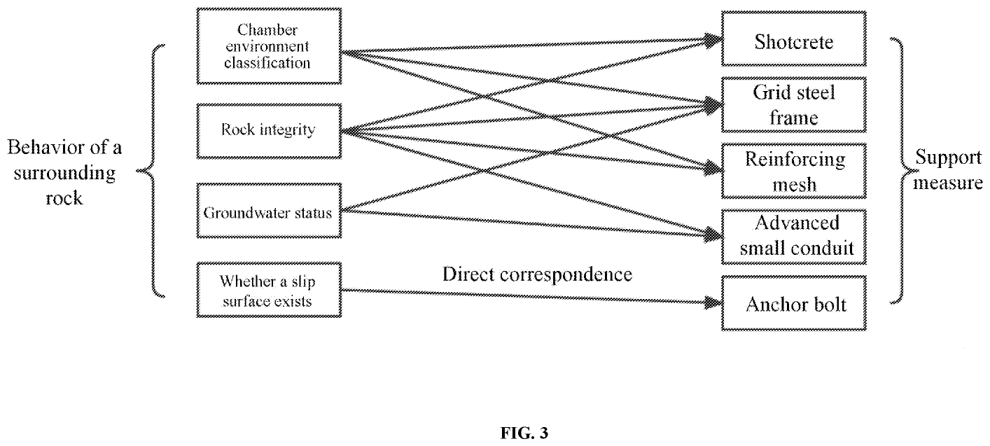

The support parameter design method provided in the present disclosure separately peels off a support effect provided by each support measure, as a basis for corresponding the behavior indicators of the surrounding rock to the support parameters. As shown in FIG. 3, a support effect provided by a split support measure is analyzed as follows:
1. Shotcrete: In addition to gluing a joint fissure and isolating water and air, the shotcrete is also used to improve a stress state of the surrounding rock, provide radial support force, and enhance strength of the surrounding rock. Therefore, the shotcrete thickness is only related to the chamber environment classification and the rock integrity.
2. Triangular grid: The triangular grid is generally used together with the shotcrete. The triangular grid is mainly used to limit deformation of the surrounding rock together with the shotcrete and serve as a support point for advanced small conduit support. Therefore, selection of a triangular grid spacing is not only related to a surrounding rock environment classification of a chamber and the rock integrity, but also related to parameters of the advanced small conduit. Based on a support effect of the advanced small conduit, it is known that the parameters of the advanced small conduit correspond to the groundwater development level and the lock integrity.
3. Reinforcing mesh: The reinforcing mesh is generally used together with the shotcrete and is mainly used to increase integrity and toughness of the shotcrete. Therefore, selection of parameters of the reinforcing mesh is also related to the chamber environment classification and the rock integrity.
4. Advanced small conduit: The advanced small conduit support is generally to perform grouting reinforcement by using the advanced small conduit. After slurry is injected into a soft and loose stratum or a hydrous fractured surrounding rock crack, the slurry can be in close contact with the soft and loose stratum or the hydrous fractured surrounding rock crack and solidified. Therefore, selection of the parameters of the advanced small conduit is only related to the rock integrity and the groundwater development level.
5. Anchor bolt: The anchor bold is mainly used to fix a loose rock block on a stable rock mass, thereby locally strengthening the integrity of the surrounding rock. Therefore, selection of the anchor bolt is only related to whether the slip surface exists.

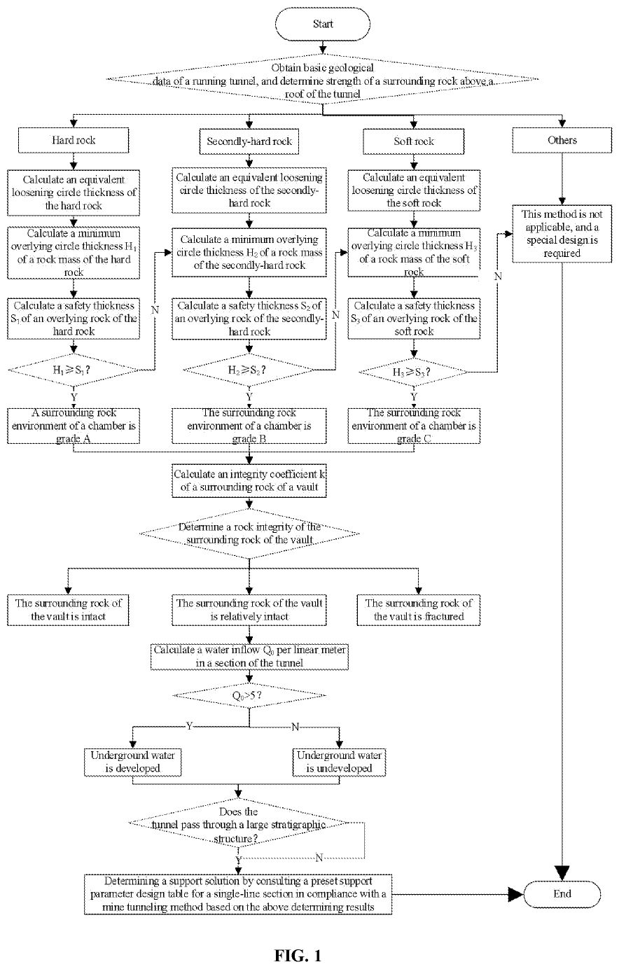

As shown in FIG. 1, a method for selecting parameters for tunnel support based on engineering-oriented behavior discrimination of surrounding rock provided in the present disclosure includes the following steps.

In step 1, basic geological data of a running tunnel is obtained, a model of a relative location relationship between the running tunnel and a stratum is established, and a chamber environment classification of a surrounding rock of the running tunnel is determined.

In step 2, rock integrity of the surrounding rock of the running tunnel is determined based on the basic geological data.

In step 3, a groundwater development level of the surrounding rock of the running tunnel is determined based on the basic geological data.

In step 4, whether there is a slip surface on the surrounding rock of the running tunnel is determined based on the basic geological data.

In step 5, support parameters are selected for a corresponding support measure based on behavior of the surrounding rock, namely the chamber environment classification, the rock integrity, the groundwater development level, and whether the slip surface exists.

In a preferred embodiment, the basic geological data includes a geological investigation report.

A working principle and a beneficial effect of the above technical solution are as follows: The chamber environment classification, the rock integrity, the groundwater development level, and whether the slip surface exists are determined for the surrounding rock of the running tunnel based on the basic geological data, and corresponding support parameters are selected for an adopted support measure based on the above determined behavior indicators. This resolves problems of insufficient logicality and poor pertinence of an existing surrounding rock classification design method, avoids designing insufficient or excessive support parameters for the running tunnel, and reduces an engineering cost of a single-line section in compliance with a mine tunneling method while ensuring safety.

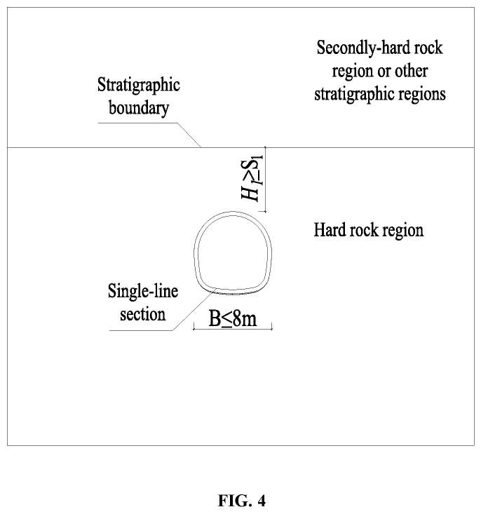

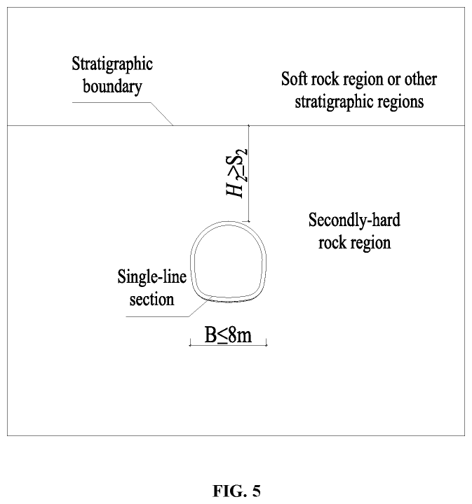

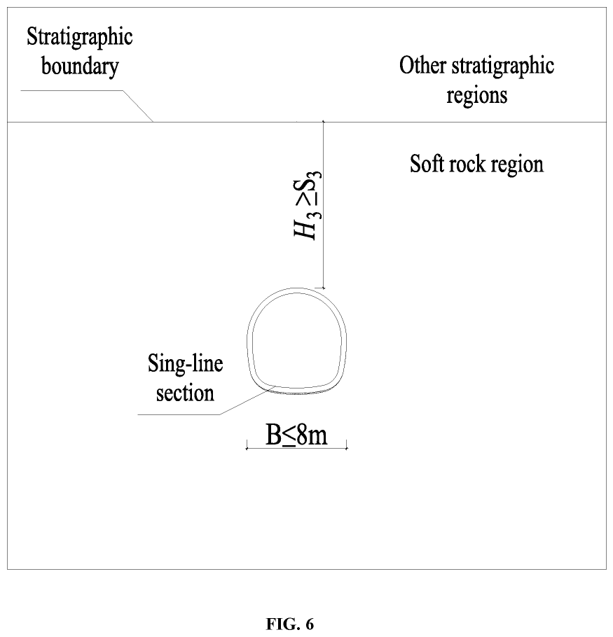

In a preferred embodiment, referring to FIG. 4 to FIG. 6, the step 1 includes the following steps.

In step 11, hardness of the surrounding rock at a location of a vault of the running tunnel is determined based on saturated uniaxial compressive strength of the rock in the basic geological data, and the vault of the running tunnel is divided into a hard rock region, a secondly-hard rock region, a soft rock region, and other stratigraphic regions based on the hardness.

In step 12, first, second, and third safety thicknesses of an overlying rock above the vault of the running tunnel are determined based on a division result of the vault.

In step 13, a first distance from the vault of the running tunnel to a top boundary of the hard rock region is determined based on the basic geological data. If the first distance is greater than or equal to the first safety thickness, the chamber environment classification of the running tunnel is determined as a grade A.

In step 14, if the first distance is less than the first safety thickness, a second distance from the vault of the running tunnel to a top boundary of the secondly-hard rock region is determined. If the second distance is greater than or equal to the second safety thickness, the chamber environment classification of the running tunnel is determined as a grade B.

In step 15, if the second distance is less than the second safety thickness, a third distance from the vault of the running tunnel to a top boundary of the soft rock region is determined. If the third distance is greater than or equal to the third safety thickness, the chamber environment classification of the running tunnel is determined as a grade C.

A working principle and a beneficial effect of the above technical solution are as follows: The hardness of the surrounding rock at the location of the vault of the running tunnel is determined based on the saturated uniaxial compressive strength of the rock in the basic geological data. The vault of the running tunnel is divided into the hard rock region, the secondly-hard rock region, the soft rock region, and the other stratigraphic regions based on the hardness. The division is based on a following table.

TABLE 1
Rock hardness classification

| | | Secondly | | |
|---|---|---|---|---|
| Hardness | Hard | hard | Soft | Others |
| Saturated uniaxial | fᵣ > 60 | 30 < fᵣ ≤ 60 | 15 < fᵣ ≤ 30 | fᵣ ≤ 15 |
| compressive | | | | |
| strength fᵣ (MPa) | | | | |

The first, second, and third safety thicknesses of the overlying rock above the vault of the interval tunnel are determined based on the division result. The first distance from the vault of the running tunnel to the top boundary of the hard rock region is determined based on the basic geological data (a positive distance is available if the vault is below the boundary, and on the contrary, a negative distance is available). If the first distance is greater than or equal to the first safety thickness, the chamber environment classification of the running tunnel is determined as the grade A. If the first distance is less than the first safety thickness, the second distance from the vault of the running tunnel to the top boundary of the secondly-hard rock region is determined. If the second distance is greater than or equal to the second safety thickness, the chamber environment classification of the running tunnel is determined as the grade B. If the second distance is less than the second safety thickness, the third distance from the vault of the running tunnel to the top boundary of the soft rock region is determined. If the third distance is greater than or equal to the third safety thickness, the chamber environment classification of the interval tunnel is determined as the grade C. If the third distance is less than the third safety thickness, it is recommended to design the support parameters specially designed by staff. In this way, a chamber environment of the running tunnel is scientifically classified.

In a preferred embodiment, the step 12 includes:

In step 121, an equivalent loosening circle thickness L of a rock stratum of the running tunnel is calculated by using a following formula based on the basic geological data:

$$L = 1.4 {r}_{t} ( {( \frac{γ h}{1.5 {f}_{r}} + 0.3 )}^{0.5} - 1 )$$

In the above formula, rₜ represents an equivalent circle radius (m) of the tunnel, rₜ=\sqrt{A/π}, A represents cross-sectional area of the running tunnel, γ represents a weight of the surrounding rock, fᵣ represents uniaxial compressive strength of the rock, and h represents a burial depth of the tunnel. The equivalent circle radius of the tunnel is specifically an equivalent circle radius of a cross-section of the running tunnel.

In step 122, a minimum overlying rock thickness of each rock stratum region on a roof of the running tunnel is determined.

A minimum overlying rock thickness of the hard rock region is calculated according to

$${H}_{1} = \sqrt{\frac{P B}{2 σ}} .$$

A minimum overlying rock thickness of the secondly-hard rock region is calculated according to

$${H}_{2} = \sqrt{\frac{3 P B}{4 σ}} .$$

A minimum overlying rock thickness of the soft rock region is calculated according to

$${H}_{3} = \sqrt{\frac{3 P B}{σ}} .$$

In the above formulas, P represents soil pressure (MPa·m) of all strata above the vault, B represents a section width (m), and σ represents flexure strength (Mpa) of the rock.

In step 123, the first, second, and third safety thicknesses of the overlying rock above the vault of the running tunnel are determined based on the equivalent loosening circle thickness L and the minimum overlying rock thickness of each rock stratum region on the roof of the running tunnel.

The above technical solution has a following beneficial effect: The first, second, and third safety thicknesses of the overlying rock above the vault of the running tunnel are calculated.

In a preferred embodiment, the step 123 includes:

In step 1231, the first safety thickness H₁ of the overlying rock above the vault of the running tunnel is determined based on the equivalent loosening circle thickness L and the minimum overlying rock thickness H₁ of the hard rock region. Specifically, H₁=1.3 (L+H₁).

In step 1232, the second safety thickness S₂ of the overlying rock above the vault of the running tunnel is determined based on the equivalent loosening circle thickness L and the minimum overlying rock thickness H₂ of the secondly-hard rock region. Specifically, H₂=1.3 (L+H₂).

In step 1233, the third safety thickness S₃ of the overlying rock above the vault of the running tunnel is determined based on the equivalent loosening circle thickness L and the minimum overlying rock thickness H₃ of the soft rock region. Specifically, H₃=1.3 (L+H₃).

A working principle of the above technical solution is as follows: The first, second, and third safety thicknesses of the overlying rock above the vault of the running tunnel are accurately calculated.

In a preferred embodiment, the step 2 includes:

In step 21, a compression wave velocity u of a rock mass and a compression wave velocity u₀ of a rock block are determined for a surrounding rock environment of the vault of the running tunnel based on the basic geological data.

In step 22, an integrity coefficient k of the running tunnel is calculated based on the compression wave velocity u of the rock mass and the compression wave velocity u₀ of the rock block:

$$k = {( \frac{u}{{u}_{0}} )}^{2} .$$

In step 23, the rock integrity of the surrounding rock of the vault is determined based on the integrity coefficient k and a preset rock integrity classification table.

In a preferred embodiment, the rock integrity is classified into three types based on the preset rock integrity classification table: intact, relatively intact, and relatively fractured.

TABLE 2
Rock integrity classification

| | | Relatively | Relatively |
|---|---|---|---|
| Rock integrity | Intact | intact | fractured |
| Integrity coefficient | k ≥ 0.55 | 0.55 > k ≥ 0.35 | 0.35 > k |

The above technical solution has a following beneficial effect: The rock integrity of the surrounding rock of the vault of the running tunnel is determined and classified.

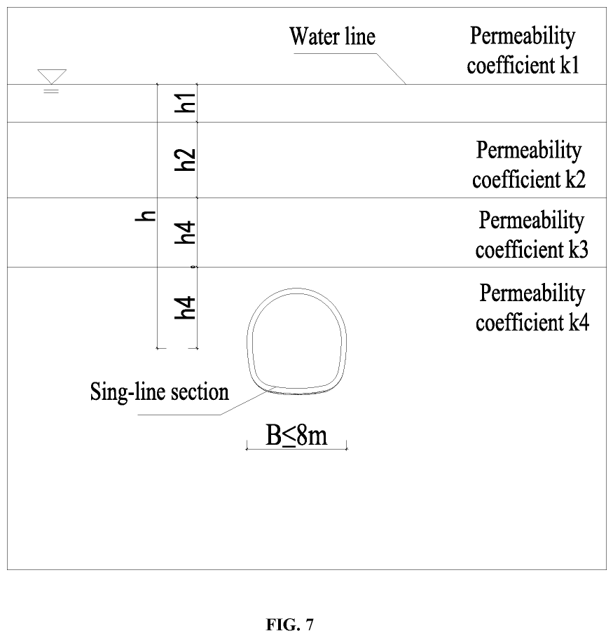

In a preferred embodiment, referring to FIG. 7, the step 3 includes:

In step 31, a distance h from a center of the running tunnel to a phreatic line and a thickness hᵢ of each different stratum between a groundwater level and the center of the running tunnel are determined based on the basic geological data.

In step 32, a permeability coefficient kᵢ of each different stratum located below the groundwater level and above the center of the running tunnel is determined based on the basic geological data.

In step 33, a comprehensive permeability coefficient K is calculated according to a following formula:

$$K = \frac{{\sum }_{i}^{n} {h}_{i}}{{\sum }_{i}^{n} ( {h}_{i} / {k}_{1} )} .$$

In step 34, the equivalent circle radius rₜ of the running tunnel is calculated according to rₜ=\sqrt{A/π}. In the above formula, A represents area of the running tunnel.

In step 35, a water inflow Q₀ per linear meter in a section is determined and calculated based on the basic geological data:

$${Q}_{0} = \frac{2 π K h}{ln ( 2 h / {r}_{t} )} .$$

In step 36, based on the water inflow Q₀ and a preset groundwater development level classification table, the groundwater development level of the surrounding rock of the running tunnel is classified into developed and undeveloped. The classification is based on a following table.

TABLE 3
Groundwater development level classification

| Groundwater | | |
|---|---|---|
| development level | Developed | Undeveloped |
| Water inflow Q₀ per | Q₀ > 5 L/min | Q₀ ≤ 5 L/min |
| linear meter (L/min) | | |

The above technical solution has a following beneficial effect: The groundwater development level of the surrounding rock of the running tunnel is classified.

In a preferred embodiment, in the step 4, whether the running tunnel passes through a large stratigraphic structural plane is determined based on the basic geological data. If the running tunnel passes through the stratigraphic structural plane, it is determined that the slip surface exists. If the running tunnel does not pass through the stratigraphic structural plane, it is determined that no slip surface exists.

The above technical solution has a following beneficial effect: Whether the running tunnel passes through the large stratigraphic structural plane is determined based on the basic geological data. If the running tunnel passes through the stratigraphic structural plane, it is determined that the slip surface exists. If the running tunnel does not pass through the stratigraphic structural plane, it is determined that no slip surface exists. In this way, whether there is the slip surface on the surrounding rock of the running tunnel is determined.

In a preferred embodiment, the step 5 includes:

In step 51, the four behavior indicators of the surrounding rock of the running tunnel are determined: the chamber environment classification, the rock integrity, the groundwater development level, and whether the slip surface exists.

In step 52, a preset table for selecting a structural support parameter is determined.

In step 53, corresponding support parameters are searched for all support measures based on the four behavior indicators of the surrounding rock of the running tunnel and the preset table for selecting the structural support parameter. The table for selecting the structural support parameter is as follows:

TABLE 4
Table for selecting a structural support parameter for a
single-line running tunnel in compliance with the mine
tunneling method in a rock region

| | Surrounding Rock Behavior | | | |
|---|---|---|---|---|
| | Chamber | | | |
| Support | Environment | Rock | Groundwater | Slip |
| Type | Classification | Integrity | Development | Surface |
| Shotcrete | Grade-A | Intact: Not | / | / |
| | environment: | adjusted | | |
| | C25 wet shotcrete | Relatively intact: | | |
| | with a thickness | Thickness + 30 mm | | |
| | of 50 mm | Relatively fractured: | | |
| | Grade B | Thickness + 50 mm | | |
| | environment: C25 | | | |
| | wet shotcrete with | | | |
| | a thickness of | | | |
| | 100 mm | | | |
| | Grade-C | | | |
| | environment: C25 | | | |
| | wet shotcrete with | | | |
| | a thickness of | | | |
| | 150 mm | | | |
| Grid steel | Grade-A | Intact: Not adjusted | / | Locally |
| frame | environment: None | Relatively intact: | | set |
| | Grade-B | Spacing of the | | |
| | environment: None | triangular steel | | |
| | Grade-C | frame @1 m | | |
| | environment: | Relatively fractured: | | |
| | Triangular grid | Spacing of the | | |
| | steel frame @1 m | triangular steel | | |
| | | frame @0.75 m | | |
| Reinforcing | Grade-A | Intact: Not adjusted | / | / |
| mesh | environment: None | Relatively intact/ | | |
| | Grade-B | fractured: | | |
| | environment: | Φ18@400 mm × | | |
| | Φ6@200 mm × | 400 mm for the | | |
| | 200 mm | grade-A and | | |
| | Grade-C | grade-B | | |
| | environment: | environments | | |
| | Φ6@200 mm × | | | |
| | 200 mm | | | |
| Advanced | Grade-A | Intact/Relatively | Undeveloped | / |
| small | environment: None | intact: Not adjusted | groundwater: | |
| conduit | Grade-B | Relatively fractured: | Not adjusted | |
| | environment: None | The Φ42 advanced | Developed | |
| | Grade-C | small conduit is | groundwater: | |
| | environment: None | disposed for an arch, | The Φ42 advanced | |
| | | with L = 3 m and a | small conduit is | |
| | | circumferential | disposed for the arch, | |
| | | spacing @500 mm | with L = 3 m and a | |
| | | | circumferential | |
| | | | spacing @500 mm | |
| Local | Grade-A | / | / | The |
| anchor bolt | environment: None | | | local |
| | Grade-B | | | anchor |
| | environment: None | | | bolt is |
| | Grade-C | | | depolyed |
| | environment: None | | | |

The above technical solution has a following beneficial effect: A support parameter of a split support measure is selected based on the four behavior indicators of the surrounding rock, namely the chamber environment classification, the rock integrity, the groundwater development level, and whether the slip surface exists.

In a preferred embodiment, in step 6, a corresponding support parameter profile design drawing is determined based on determining results of the corresponding support parameters of all the support measures.

A working principle and a beneficial effect of the above technical solution are as follows: A support parameter of each split support measure is determined, and a support parameter of each component or facility on the profile design drawing is labeled to obtain the support parameter profile design drawing. This is convenient for precise field operations.

It will be apparent to those skilled in the art that various modifications and variations can be made to the present disclosure without departing from the spirit and scope of the present disclosure. Thus, provided that these modifications and variations of the present disclosure fall within the scope of the claims of the present disclosure and their equivalents, the present disclosure will also be intended to include these modifications and variations.

1. A method for selecting parameters for tunnel support based on engineering-oriented behavior discrimination of surrounding rock, comprising:
step 1, obtaining basic geological data of a running tunnel by conducting geological investigation, establishing a model of a relative location relationship between the running tunnel and a stratum, and determining a chamber environment classification of a surrounding rock of the running tunnel;
step 2, determining rock integrity of the surrounding rock of the running tunnel based on the basic geological data;
step 3, determining a groundwater development level of the surrounding rock of the running tunnel based on the basic geological data;
step 4, determining, based on the basic geological data, whether there is a slip surface on the surrounding rock of the running tunnel; and
step 5, selecting support parameters for a corresponding support measure based on behavior of the surrounding rock including the chamber environment classification, the rock integrity, the groundwater development level, and whether the slip surface exists;
wherein the step 1 comprises:
step 11, determining hardness of the surrounding rock at a location of a vault of the running tunnel based on saturated uniaxial compressive strength of the rock in the basic geological data, and dividing the vault of the running tunnel into a hard rock region, a secondly-hard rock region, a soft rock region, and other stratigraphic regions based on the hardness;
step 12, determining first, second, and third safety thicknesses of an overlying rock above the vault of the running tunnel based on a division result of the vault;
step 13, determining a first distance from the vault of the running tunnel to a top boundary of the hard rock region based on the basic geological data, and when the first distance is greater than or equal to the first safety thickness, determining the chamber environment classification of the running tunnel as a grade A;
step 14, when the first distance is less than the first safety thickness, determining a second distance from the vault of the running tunnel to a top boundary of the secondly-hard rock region, and if the second distance is greater than or equal to the second safety thickness, determining the chamber environment classification of the running tunnel as a grade B; and
step 15, when the second distance is less than the second safety thickness, determining a third distance from the vault of the running tunnel to a top boundary of the soft rock region, and if the third distance is greater than or equal to the third safety thickness, determining the chamber environment classification of the running tunnel as a grade C;
wherein the step 2 comprises:
step 21, determining a compression wave velocity u of a rock mass and a compression wave velocity u₀ of a rock block for a surrounding rock environment of the vault of the running tunnel based on the basic geological data;
step 22, calculating an integrity coefficient k of the running tunnel based on the compression wave velocity u of the rock mass and the compression wave velocity u₀ of the rock block:
$$k = {( \frac{u}{{u}_{0}} )}^{2} ;$$
and
step 23, determining the rock integrity of the surrounding rock of the vault based on the integrity coefficient k and a preset rock integrity classification table;
wherein the step 3 comprises:
step 31, determining, based on the basic geological data, a distance h from a center of the running tunnel to a phreatic line and a thickness hᵢ of each different stratum between a groundwater level and the center of the running tunnel;
step 32, determining, based on the basic geological data, a permeability coefficient kᵢ of each different stratum located below the groundwater level and above the center of the running tunnel;
step 33, calculating a comprehensive permeability coefficient K according to a following formula:
$$K = \frac{{\sum }_{i}^{n} {h}_{i}}{{\sum }_{i}^{n} ( {h}_{i} / {k}_{i} )}$$
step 34, calculating an equivalent circle radius rₜ of the running tunnel according to rₜ=\sqrt{A/π}, wherein A represents area of the running tunnel;
step 35, calculating a water inflow Q₀ per linear meter in a section based on the basic geological data:
$${Q}_{0} = \frac{2 π Kh}{\text{?} ( 2 h / {r}_{t} )} ;$$
$$\text{?} \text{indicates text missing or illegible when filed}$$
and
step 36, based on the water inflow Q₀ and a preset groundwater development level classification table, classifying the groundwater development level of the surrounding rock of the running tunnel into developed and undeveloped;
wherein the step 4 comprises: determining, based on the basic geological data, whether the running tunnel passes through a large stratigraphic structural plane; and when the running tunnel passes through the stratigraphic structural plane, determining that the slip surface exists; or when the running tunnel does not pass through the stratigraphic structural plane, determining that no slip surface exists;
wherein the step 5 comprises:
step 51, determining four behavior indicators of the surrounding rock of the running tunnel: the chamber environment classification, the rock integrity, the groundwater development level, and whether the slip surface exists;
step 52, determining a preset table for selecting a structural support parameter; and
step 53, searching for support parameters for all support measures based on the four behavior indicators of the surrounding rock of the running tunnel and the preset table for selecting the structural support parameter.

2. The method according to claim 1, wherein the step 12 comprises:
step 121, calculating an equivalent loosening circle thickness L of a rock stratum of the running tunnel by using a following formula based on the basic geological data:
$$L = 1.4 {r}_{t} ( {( \frac{γ h}{1.5 {f}_{r}} + 0.3 )}^{0.5} - 1 )$$
wherein rₜ represents an equivalent circle radius of the tunnel, rₜ=\sqrt{A/π}, A represents cross-sectional area of the running tunnel, γ represents a weight of the surrounding rock, fᵣ represents uniaxial compressive strength of the rock, and h represents a burial depth of the tunnel;
step 122, determining a minimum overlying rock thickness of each rock stratum region on a roof of the running tunnel, wherein
a minimum overlying rock thickness of the hard rock region is calculated according to
$${H}_{1} = \sqrt{\frac{PB}{2 σ}} ;$$
a minimum overlying rock thickness of the secondly-hard rock region is calculated according to
$${H}_{2} = \sqrt{\frac{3 PB}{4 σ}} ;$$
and
a minimum overlying rock thickness of the soft rock region is calculated according to
$${H}_{3} = \sqrt{\frac{3 PB}{σ}} ,$$
wherein
P represents soil pressure of all strata above the vault, B represents a section width, and σ represents flexure strength of the rock; and
step 123, determining the first, second, and third safety thicknesses of the overlying rock above the vault of the running tunnel based on the equivalent loosening circle thickness L and the minimum overlying rock thickness of each rock stratum region on the roof of the running tunnel.

3. The method according to claim 2, wherein the step 123 comprises:
step 1231, determining the first safety thickness S₁ of the overlying rock above the vault of the running tunnel based on the equivalent loosening circle thickness L and the minimum overlying rock thickness H₁ of the hard rock region;
step 1232, determining the second safety thickness S₂ of the overlying rock above the vault of the running tunnel based on the equivalent loosening circle thickness L and the minimum overlying rock thickness H₂ of the secondly-hard rock region; and
step 1233, determining the third safety thickness S₃ of the overlying rock above the vault of the running tunnel based on the equivalent loosening circle thickness L and the minimum overlying rock thickness H₃ of the soft rock region.

4. The method according to claim 1, wherein the rock integrity is classified into three types based on the preset rock integrity classification table: intact, relatively intact, and relatively fractured.

5. The method according to claim 1, further comprising a step 6: determining a corresponding support parameter profile design drawing based on determining results of the support parameters of all support measures.
